(19) United States
(12) Patent Application Publication
(10) Pub. No.: US 2024/0249154 A1
(43) Pub. Date: Jul. 25, 2024

(54) KNOWLEDGE GRAPH REASONING SYSTEMS USING SELF-SUPERVISED REINFORCEMENT LEARNING AND METHODS THEREOF

(71) Applicants: University of Central Florida Research Foundation, Inc., Orlando, FL (US); Google LLC, Mountain View, CA (US)

(72) Inventors: Ying Ma, Orlando, FL (US); Owen Burns, Orlando, FL (US); Mingqiu Wang, Mountain View, CA (US)

(21) Appl. No.: 18/420,200

(22) Filed: Jan. 23, 2024

Related U.S. Application Data
(60) Provisional application No. 63/440,534, filed on Jan. 23, 2023.

(51) Int. Cl. G06N 5/02; G06N 3/092

(52) U.S. Cl. CPC G06N 5/02; G06N 3/092

(57) ABSTRACT

Described herein relates to a self-supervised reinforced learning (hereinafter “SSRL”) system for question-and-answer query systems that may include one or more initial steps to prime a neural network to prevent an agent from prematurely selecting an early path and method thereof. The SSRL method may also provide the agent with a lead for queries with a large action space, such that at least one existing reinforced learning system may be improved (e.g., accuracy). Additionally, to scale to larger datasets in which label generation for each training sample is infeasible, the SSRL system may include one or more steps of pretraining the dataset(s) with partial labels, which may be generated from a subset of a whole knowledge graph.

### CROSS-REFERENCE TO RELATED APPLICATIONS

This Nonprovisional patent application claims priority to U.S. Provisional Patent Application No. 63/440,534 entitled “KNOWLEDGE GRAPH REASONING SYSTEMS USING SELF-SUPERVISED REINFORCEMENT LEARNING AND METHODS THEREOF” filed Jan. 23, 2023 by the same inventors, all of which is incorporated herein by reference, in its entirety, for all purposes.

### BACKGROUND OF THE INVENTION

### 1. Field of the Invention

This invention relates, generally, to knowledge graphs used in question-and-answer and recommendation systems. More specifically, it relates to a self-supervised reinforcement learning system and method that includes supervised pretraining stages to create multiple paths during a query answer prompt, efficiently exploring knowledge paths to find an optimal correct path, rather than an initial correct path.

### 2. Brief Description of the Prior Art

Knowledge graphs (hereinafter “KG”) support a variety of downstream tasks, such as question answering and recommendation systems, including those involved in smart home and other electronic device assistant applications (Yu et al. 2022), (He et al. 2017), (Moon et al. 2019), (Huang et al. 2019). Since practical KGs often fail to include all of the relevant facts in a question-and-answer or recommendation system, knowledge graph completion (KGC) processes include inferring missing facts automatically for a given KG. The two main branches of KGC are embedding-based methods (Yang et al. 2015), (Dettmers et al. 2018), (Toutanova et al. 2016) and path-based methods (Das et al. 2017), (Guu, Miller, and Liang 2015), (Lao, Mitchell, and Cohen 2011), (Neelakantan, Roth, and McCallum 2015), (Toutanova et al. 2016), (Yang, Yang, and Cohen 2017), (Rocktäschel and Riedel 2017).

Path-based methods provide reasoning paths on the graph and infer missing facts; as such, path-based KGC may be referred to as knowledge graph reasoning (hereinafter “KGR”). Across such path-based methods, formulating the KGR task as a sequential decision problem and solving the task with deep reinforcement learning (hereinafter “RL”) neural networks achieves state of the art results. (Das et al. 2018), (Shen et al. 2018) (Lin, Socher, and Xiong 2018). Compared to path-based methods, embedding-based methods cannot capture more complex reasoning patterns and are less interpretable.

During a question-and-answer or recommendation query, KGs represent a static and fully deterministic environment in which the answer entities typically reside in the near neighborhood of the start entity. For example, in the FB15K-237 dataset (Toutanova et al. 2015), 99.8% queries have a correct answer within a 3-hop neighborhood with respect to the start entity. Such a structure enables the finding of ground-truth paths, and the network can be trained in a supervised manner.

However, since KGs typically utilize RL neural networks, the goal is to find at least one correct path from the start entity responsive to a query, with the goal being to reach a target entity. While different paths can include a correct target entity, including target entities with more correct responses to queries, the RL agent terminates a search upon the finding of one correct path. In this way, RL networks include reduced learning speeds without the need to generate and store path labels, since the RL networks can begin learning upon the finding of one correct path.

On the other hand, supervised learning (hereinafter “SL”) networks aim to find all correct paths and all correct target entities with respect to the start entity, with the loss function goal of SL being to minimize the distance between the policy and the label at each decision step. As such, SL networks provide broader coverage as compared to RL networks, such that SL agents outperform RL agents in situations that are unfamiliar to the RL agents and/or include large numbers of possible actions. However, SL networks require greater learning times since each correct path for a given query must be learned; this in turn requires a label-generating process that leverages additional computational resources, allowing the SL networks to scale up from typical RL network functionality at the expense of increased time and computational requirements. A comparison of RL and SL networks is shown in FIG. 1.

Accordingly, what is needed is a self-supervised reinforced learning system that leverages the broader coverage of supervised learning networks with the speed of reinforced learning systems, including a scaling component in which larger datasets are pretrained with partial labeling. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a method of finding reasoning pathways in a knowledge graph, in real-time. In an embodiment, the method may comprise the following steps: (a) automatically generating, via at least one processor of a computing device, partial labels for a dataset, such that the partial labels may be generated from a subset of the knowledge graph; (b) pretraining, via a supervised learning module and/or a reinforced learning module, a neural network; and (c) subsequent to generating partial labels and/or pretraining the neural network, automatically selecting, via the at least one processor of the computing device, an optimal reasoning pathway from a start entity to a target entity for a question-and-answer query using the knowledge graph.

In some embodiments, the step of automatically generating partial labels of a dataset may further comprise the step of, determining the start entity and the target entity. The step of automatically generating partial labels of a dataset may also comprise the step of, calculating a correct path between the start entity and the target entity. In these other embodiments, the step of automatically generating partial labels of a dataset may further comprise the step of, removing, for each correct path, any correct paths that include a self-loop outside of the calculated correct path.

Additionally, in some embodiments, the step of automatically generating partial labels of a dataset may further comprise the step of, adding to a target set, for each correct path, all parent nodes for each node visited from the start entity to the target entity. In this same manner, the step of automatically generating partial labels of a dataset may also comprise the step of, generating the partial labels based on the target set.

In some embodiments, the step of pretraining a neural network may further comprise the step of, performing a supervised learning module using the generated partial labels by sampling, via an agent, a policy action on the target set to map each correct path between the start entity and the target entity. In addition, in these other embodiments, the step of pertaining a neural network may further comprise the step of, subsequent to performing the supervised learning module, performing a reinforced learning module using the sampled policy action by applying the sampled policy action to the dataset to maximize a reward for the agent.

In some embodiments, the method may also comprise the step of, retraining, via the at least one processor, the supervised learning module and/or the reinforced learning, such that the supervised learning module and/or the reinforced learning module may be trained by minimizing a distance between the sampled policy action and the partial labels.

Moreover, another aspect of the present disclosure pertains to a path-finding system of finding reasoning pathways in a knowledge graph. In an embodiment, the path-finding system may comprise the following: (a) at least one processor; and (b) a non-transitory computer-readable medium operably coupled to the at least one processor, the computer-readable medium having computer-readable instructions stored thereon that, when executed by the at least one processor, cause a path-finding system to select an optimal reasoning pathway from a start entity to a target entity for a question-and-answer query by executing instructions comprising: (i) automatically generating, via at least one processor of a computing device, partial labels for a dataset, such that the partial labels may be generated from a subset of a knowledge graph; (ii) pretraining, via a supervised learning module and/or a reinforced learning module, a neural network; and (iii) subsequent to generating partial labels and/or pretraining the neural network, automatically selecting, via the at least one processor of the computing device, the optimal reasoning pathway from the start entity to the target entity for the question-and-answer query using the knowledge graph.

In some embodiments, the step of automatically generating partial labels of a dataset of the executed instructions may further comprise the step of, determining the start entity and the target entity. The step of automatically generating partial labels of a dataset of the executed instructions may also comprise the step of, calculating a correct path between the start entity and the target entity. In these other embodiments, the step of automatically generating partial labels of a dataset of the executed instructions may further comprise the step of, removing, for each correct path, any correct paths that include a self-loop outside of the calculated correct path.

Additionally, in some embodiments, the step of automatically generating partial labels of a dataset of the executed instructions may further comprise the step of, adding to a target set, for each correct path, all parent nodes for each node visited from the start entity to the target entity. In this same manner, the step of automatically generating partial labels of a dataset of the executed instructions may also comprise the step of, generating the partial labels based on the target set.

In some embodiments, the step of pretraining a neural network of the executed instructions may further comprise the step of, performing a supervised learning module using the generated partial labels by sampling, via an agent, a policy action on the target set to map each correct path between the start entity and the target entity. In addition, in these other embodiments, the step of pertaining a neural network of the executed instructions may further comprise the step of, subsequent to performing the supervised learning module, performing a reinforced learning module using the sampled policy action by applying the sampled policy action to the dataset to maximize a reward for the agent.

In some embodiments, the executed instructions may also comprise the step of, retraining, via the at least one processor, the supervised learning module and/or the reinforced learning, such that the supervised learning module and/or the reinforced learning module may be trained by minimizing a distance between the sampled policy action and the partial labels.

Furthermore, an additional aspect of the present disclosure pertains to a method of automatically finding reasoning pathways in a knowledge graph. In an embodiment, the method may comprise the following steps: (a) generating partial labels for a dataset by: (i) determining a start entity and a target entity; (ii) calculating a correct path between the start entity and the target entity; (iii) removing, for each correct path, any correct paths that include a self-loop outside of the calculated correct path; (iv) adding to a target set, for each correct path, all parent nodes for each node visited from the start entity to the target entity; and (v) generating the partial labels based on the target set, such that the partial labels may be generated from a subset of the knowledge graph; (b) pretraining a neural network by: (i) performing a supervised learning module using the generated partial labels by sampling, via an agent, a policy action on the target set to map each correct path between the start entity and the target entity; and (ii) subsequent to performing the supervised learning module, performing a reinforced learning module using the sampled policy action by applying the sampled policy action to the dataset to maximize a reward for the agent; and (c) subsequent to generating the partial labels and/or pretraining the neural network, automatically selecting an optimal reasoning pathway from the start entity to the target entity for a question-and-answer query using the knowledge graph.

In some embodiments, the method may further comprise the step of, retraining, via the at least one processor, the supervised learning module and/or the reinforced learning, such that the supervised learning module and/or the reinforced learning module may be trained by minimizing a distance between the sampled policy action and the partial labels.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a graphical exemplification of a comparison of supervised learning (SL) networks and reinforced learning (RL) networks, according to an embodiment of the present disclosure.

FIG. 2 is a graphical exemplification of an overview of a system architecture of a self-supervised reinforced learning system, according to an embodiment of the present disclosure.

FIG. 3 is a graphical exemplification of a seeding label generation process, according to an embodiment of the present disclosure, including: a 3-hop neighborhood with respect to a start entity ez, including a dashed line representing a missing link which must be inferred (Section A); the removal of a link between node e₂ and node e₅, and a self-loop of all nodes other than eall (Section B); a first round of traverse in which nodes previously visited are added to set M (Section C); marking nodes in a correct path in red (Section D); and the generation of labels for the remaining nodes in C (Section E and Section F).

FIG. 4 is a graphical exemplification of reasoning paths discovered by a system architecture of a self-supervised reinforced learning system and/or RL-only agents, according to an embodiment of the present disclosure.

FIG. 5 is a plot of learning curves (plotting accuracy vs. the number of training batches) with different supervised learning pretraining steps followed by reinforced learning steps, according to an embodiment of the present disclosure, including: the FB15K-237 dataset (Section A); the WN18RR dataset (Section B); the NELL-995 dataset (Section C); and the FB60K dataset (Section D).

FIG. 6 is a graphical depiction of heatmaps of MRR evaluations of one-to-many and many-to-one queries, according to an embodiment of the present disclosure, including: the FB15K-237 dataset (Section A); and the WN18RR dataset (Section B).

FIG. 7 is a graphical depiction of heatmaps of positive triples in the top k positions of a dataset (Hits@k) and mean reciprocal rank (MRR) metrics for different supervised learning training epochs followed by reinforced learning training, in which row 0 represents a pure reinforced learning system, according to an embodiment of the present disclosure, including: the FB15K-237 dataset (Section A); the WN18RR dataset (Section B); the NELL-995 dataset (Section C); and the FB60K dataset (Section D). The value in each cell is the score of that cell minus the score for that category at epoch 0, thereby highlighting the differences from the baseline reinforced learning system.

FIG. 8 is a graph of distribution of relations, according to an embodiment of the present disclosure, including: the FB15K-237 dataset (Section A); the WN18RR dataset (Section B); the NELL-995 dataset (Section C); and the FB60K dataset (Section D). The vertical lines correspond to the accuracy of the agent on that relation that increases over the course of training.

FIG. 9 is a plot of learning curves (plotting the percentage of correct trials vs. the number of training batches) with different supervised learning pretraining steps followed by reinforced learning steps, according to an embodiment of the present disclosure, including: the FB15K-237 dataset (Section A); the WN18RR dataset (Section B); the NELL-995 dataset (Section C); and the FB60K dataset (Section D).

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

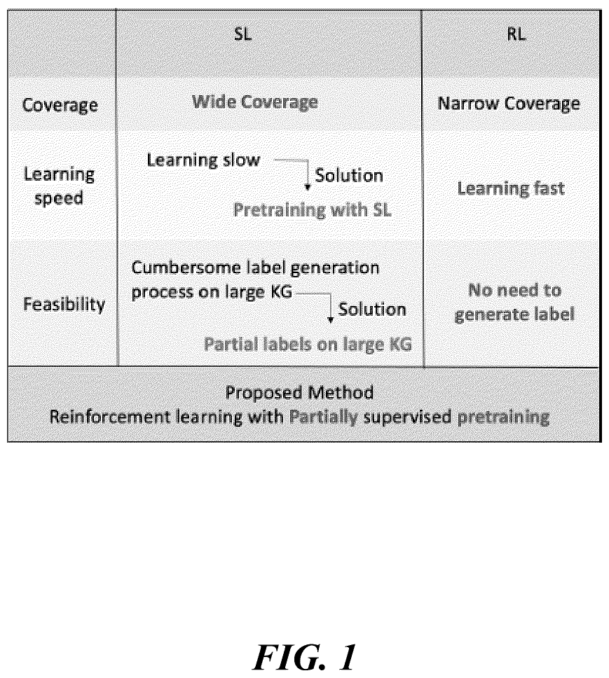

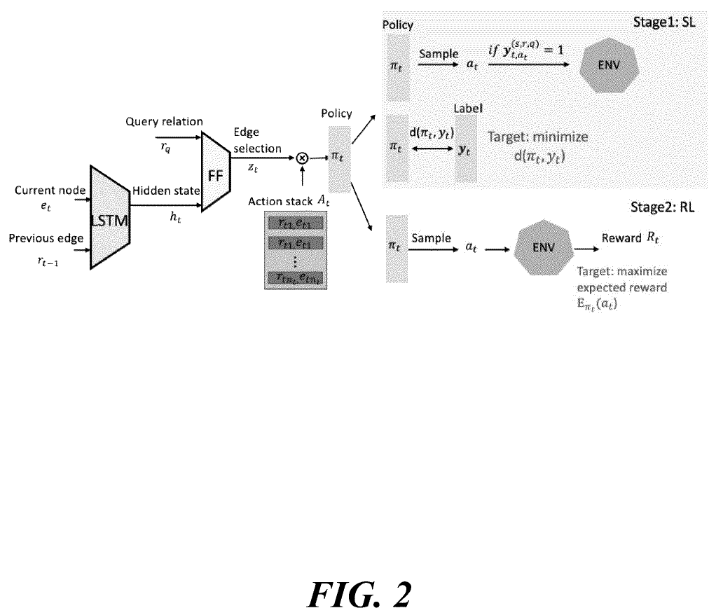

Accordingly, the relevant descriptions of such features apply equally to the features and related components among all the drawings. For example, any suitable combination of the features, and variations of the same embodiment, described with components illustrated in FIG. 1, can be employed with the components of FIG. 2, and/or vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g. circuitry), as programmable circuitry appropriately programmed with software and/or firmware, or as a combination of special-purpose and programmable circuitry. Hence, embodiments may include a computer-readable medium having stored thereon instructions which may be used to program a computer (or other electronic devices) to perform a process.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the present invention may be written in any combination of one or more programming languages, including an object oriented programming language such as Java, C #, C++, Python, MATLAB, and/or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system), (e.g., the degree of precision required for a particular purpose, such as generating knowledge graph reasoning systems using self-supervised reinforcement learning). As used herein, “about,” “approximately,” or “roughly” refer to within +25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Self-Supervised Reinforcement Learning System

An aspect of the present disclosure pertains to a self-supervised reinforced learning (hereinafter “SSRL”) system (hereinafter “SSRL system” and/or “SSRL framework”) and method thereof. In an embodiment, the SSRL system and/or method may comprise one or more initial steps to prime the network to prevent an agent (e.g., a RL-agent and/or a SL-agent) from prematurely selecting an early path, and/or instead may provide the agent with a lead for queries with a large action space, improving over existing reinforced learning systems. To scale to larger datasets in which label generation for each training sample is infeasible, the system may include one or more steps of pretraining the dataset(s) with partial labels generated from a subset of the whole knowledge graph. In this embodiment, the SSRL system may comprise a computing device having at least one processor, such that the at least one processor may be configured to implement the one or more initial steps to prevent the agent from selecting the early path and/or the one or more steps of pretraining the dataset(s) with partial labels.

In an embodiment, the SSRL system may comprise a knowledge graph reasoning (KGR) task. As such, the KGR may be represented as [symbol] =( [symbol] ), where [symbol] is the set of entities e∈ [symbol] and [symbol] is the set of directed relations r∈ [symbol] between two entities. In this manner, an embodiment of the KGR task may be defined such that, given a query (eₛ,r_{q},e_{q}), where eₛ is the source entity, r_{q} is the relation of interest, and e_{q} is the target entity which is unknown, the goal of KGR may be to infer e_{q} by finding paths starting from eₛ (i.e., {(eₛ, e₀, e₁), (e₁, r₁, e₂), . . . , (eₜ, rₜ, eₜ₊₁), . . . (eₙ, rₙ, e_{q})}. The subscript t may also be used to denote the relation/node visited at each time step t; in addition, eI (rI) may be used to represent the Ith entity (relation) which is the unique identification (ID) of each entity (relation), and/or eₜ (rₜ) may be used to represent the entity (relation) visited at time t. In this embodiment, the KGR and/or the broader problem of knowledge graph completion (KGC) (also named query-answering or link-prediction) may be directed toward the goal of inferring eₜ given a query (eₛ,r_{q},?). However, KGRs are more difficult to successfully resolve than KGCs, since reasoning paths may not be required for KGCs, and/or embedding-based methods which learn a scoring function ƒ(eₛ,r,eₜ) for triples in a KG and return eₜ's which the highest scores; however, KGRs may only be solved by the path-based methods.

Additionally, in an embodiment, the SSRL system may be configured to implement the path-finding process, such that the path-finding process may be viewed as a partially observed deterministic Markov Decision Process (MDP) where the agent may start from the source entity eₛ and/or may sequentially select the outgoing edges for predefined T steps. In this manner, the MDP may be formally defined by the 5-tuple (S, O, A, R, δ), where S is the set of states, O is the set of observations, A is the set of actions, R is the reward function, and & is the state transition function. The state sₜ∈S at time t is a 4-tuple sₜ=(eₛ, r_{q}, e_{q}, eₜ), where eₜ is the entity visited at time t. Moreover, in this embodiment, the environment may only be partially observed, as the agent may not know the target entity e_{q}. The observation oₜ∈O at time t is a 3-tuple sₜ=(eₛ, r_{q}, eₜ), where eₛ and r_{q} are the context information for each query and eₜ is the state-dependent information.

In an embodiment, the possible actions Aₜ∈A at time t may all be outgoing edges connected to eₜ, Aₜ={(r,e)|(eₜ,r,e)∈ [symbol] }. A self-loop action NO_OP may also be added to every Aₜ, such that the agent may be given the option to stay on a specific node for any number of steps, in case the correct answer is reached at t<T. In addition, in this embodiment, a reverse link may also be added to each triple (adding (e₁, r⁻¹, e₂) for every (e₂,r,e₁)), allowing the agent to automatically undo potentially incorrect decisions, in real-time. In this manner, the agent may receive a terminal reward 1 if the agent reaches the correct answer e_{q} at time T, and/or the agent may receive 0 otherwise (i.e., R(s_{T})= [symbol] {e_{T}=e_{q}}. As such, in this embodiment, the environment may be entirely determined by the graph and/or the environment may evolve deterministically, with the transition function defined by δ(sₜ,aₜ)=sₜ₊₁, where at is the action selected at time t.

Moreover, in an embodiment, the at least one processor of the SSRL system may be communicatively coupled to at least one neural network (hereinafter “network”). In this embodiment, the network may be utilized to predict the policy πₜ=P(Aₜ), e.g., the probability of possible action at time t. The network architecture is depicted in FIG. 2 and will be described in greater detail below. In this embodiment, a long short-term memory network (LSTM) may also be adopted and/or communicatively coupled to the at least one processor of the SSRL system to encode state-dependent information into a vector hₜ under Eq. 1

$${h}_{t} = LSTM ( [ {r}_{t - 1} ; {e}_{t} ] ) \qquad ( 1 )$$

In the above equation, eₜ∈ [symbol] ^{d} and rₜ∈ [symbol] ^{d} may be defined as vectors representations of the entity and the selected edge at time t, and/or [;] denotes the vector concatenation.

Subsequently, in an embodiment, the history embedding hₜ and/or the query relation embedding r_{q} may be concatenated before being fed into a feed-forward network with rectified linear unit (ReLU) nonlinearity parameterized by W₁. Since r_{q} is context information and time invariant, a feed-forward network of the SSRL system may be capable of encoding and/or extracting information from r_{q}. The action space may also be encoded by stacking the embeddings of all possible actions into a matrix Aₜ∈ [symbol] ⁿ^{ₜ}^{×2d}, where nₜ is the number of actions of the entity eₜ, which varies for different entities eₜ. The policy is calculated by Eq. 2 and Eq. 3

$${z}_{t} = {W}_{2} ReLU ( {W}_{2} [ {h}_{t} ; {r}_{1} ] ) \qquad ( 2 )$$

$${π}_{t} = σ ( {A}_{t} \times {z}_{t} ) \qquad ( 3 )$$

In the above equation, σ represents the softmax function, zₜ represents the action selection vector, and/or the probability of taking action aₜ may be determined by the similarity (the inner product) between zₜ and the corresponding element in Aₜ.

In an embodiment, in KGs, the same start entity eₛ and/or relation r may connect to many different target entities or connections. Eₐₗₗ is used to represent the set of all end entities of (eₛ,r,?), and the policy network may be primed for wider coverage by, for query (eₛ,t,e_{q}), marking as correct paths all paths connecting eₛ with all entities in Eₐₗₗ with relation r, which differs from finding a random correct path between eₛ and e_{q}. The generated labels of entity eₜ for query (eₛ,r,e_{q}) is represented in the form of Eq. 4

$$L ( ( s , r , q ) , {e}_{t} ) = {y}_{t}^{( s , r , q )} ∈ {ℝ}^{{n}_{t}} \qquad ( 4 )$$

In the above equation, yₜ^{(s,r,q)} represents the label of the entity visited at time step t and yI^{(s,r,q)} represents the label for the entity, eI. The first element of yₜ^{(s,r,q)} represents self-connection; as such, the label of entity eₜ∈Eₐₗₗ is yₜ^{(s,t,q)}=[1,0,0, . . . ]^{T} (i.e., the first element is one and all other elements are zeroes; and the vector length is the same as the number of possible actions at time t), indicating a correct answer.

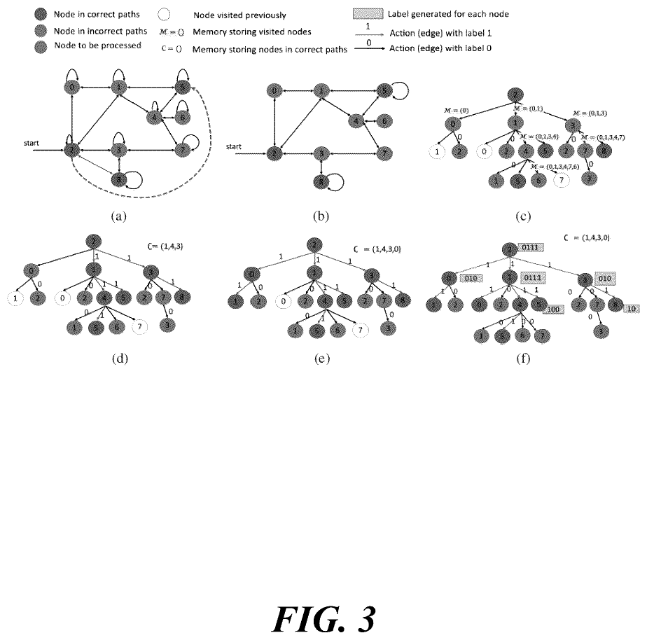

In an embodiment, all other nodes on the correct paths may be found and/or labeled with breadth first search (hereinafter “BFS”) of the SSRL system with a memory of the nodes visited M used to avoid repeated generation of labels of the same node. For example, as shown in Section A of FIG. 3, in some embodiments, the query (e₂,r₁,e₅) by the SSRL system may include a 3-hop neighborhood of the start entity e₂, and a fact (e₂,r₁,e₈) exists in the graph (Eₐₗₗ=(e₅, e₈)). As such, paths connecting e₂ with both e₅ and e₈ may each be marked as correct paths.

Furthermore, an exemplary process is provided below, disclosing a method of automatically finding reasoning pathways in a knowledge graph, in real-time, via the SSRL system. The steps delineated are merely exemplary of automatically finding reasoning pathways in a knowledge graph, in real-time, via the SSRL system. The steps may be carried out in another order, with or without additional steps included therein

As such, in an embodiment, during step 1, self-loops of all nodes may be removed, except for the nodes in Eₐₗₗ, as depicted in Section B of FIG. 3. The self-loop nodes for nodes in Eₐₗₗ may be maintained to allow the agent to remain at these target nodes one reaching the target nodes. The labels for e₅ and e₈ are yₜ^{(2,1,5)}=[1,0,0] and y₈^{(2,1,5)}=[1,0], respectively. The first element in each label may represent self-connection.

In an embodiment, during step 2, BFS may be implemented to find entities in Eₐₗₗ. To avoid going back, the labels for the parent node may also be marked directly as zero without further searching, such as e₂ for nodes e₀, e₁, e₃ shown in gray in Section C of FIG. 3. In this manner, visited nodes may also added to the set M to avoid being processed more than once. For example, in some embodiments, since e₀ and e₁ may have already been visited and/or added to M in the first hop, they may then be marked with empty circles indicating no further search. Finally, three paths may be found: e₂→e₁→e₄→e₅, e₂→→e₁→e₅, and e₂→e₃→e₈, as shown in Section D of FIG. 3. All notes in the correct paths may be stored in the set C=(e₁,e₄,e₃).

In an embodiment, during step 3, for each node eI∈C, all of the parent nodes may be added to C and/or the process may be repeated recursively until the source node may be reached. For example, in some embodiments, for node e₁, since there is a path e₂→e₀→e₈, node e₀ may be added to C, as shown in Section E of FIG. 3.

Additionally, in an embodiment, during step 4, the labels for nodes eI∈C may be generated. Since the agent only selects edges in correct paths in the SL stage (as explained in greater detail in the sections below), there may be no need to generate labels for nodes eI∉C such as e₆ and e₇. As such, all the unlabeled edges connecting to nodes in C may be labeled as ones. In this manner, all other edges may be labeled as zeros; the labels for all nodes in C are shown in Section F of FIG. 3. The first element nodes e₀, e₁, e₂, e₄ is set as 0 to encourage the agent to explore other nodes in the environment when the target nodes have not been reached yet.

Returning to FIG. 2, the SSRL two-stage training framework is shown in detail. In an embodiment, during the SL stage, the policy network may be trained in a SL manner using the labels generated during the previously-described section. In this embodiment, the agent may sample the action based on the policy πₜ approximated by the network in accordance with Eq. 5:

$${π}_{t} \sim Categorical ( {π}_{t} ) \qquad ( 5 )$$

In this embodiment, in order to travel on only the correct paths, the agent may apply the selected action to the environment only if the label of that action is one (i.e., y_{t,a}_{ₜ}^{(s,r,q)}=1. Otherwise, the agent may stay on the current node. The goal is to minimize the distance between πₜ and yₜ^{(s,r,q)}, such as by using the cross entropy loss as the cost function in accordance with Eq. 6:

$$\begin{matrix}{L}_{SL} ( θ ) = d ( {π}_{t} , {y}_{t}^{( s , r , q )} ) \\ = - \frac{1}{{n}_{t}} {\sum }_{i = 1}^{{n}_{t}} ( {y}_{t , i}^{( s , r , q )} log {π}_{t , i} + ( 1 - {y}_{t , i}^{( s , r , q )} log ( 1 - {π}_{t , i} ) )\end{matrix} , \qquad ( 6 )$$

As such, in the above equation, i represents the index of the element in vector yₜ^{(s,r,q)} and/or πₜ, and/or the parameters θ of the policy network may be updated with stochastic gradient descent. For example, as shown in FIG. 3, in some embodiments, the labels of entity e₂ and e₃ may be [0,1,1,1]^{T} and [0,1,0]^{T}, respectively. In this manner, if the agent starts from e₂ and selects an action a₀=3 at time 0, the agent may traverse to node e₃. At time 1, if the sampled action is a₁=2, then the agent may be configured to stay at entity e₃ instead of traversing to e₇, since a₁=2 is not a valid action y_{1,2}^{(s,r,q)}=0.

Note, in an embodiment, the environment exploration strategy and/or loss function used in the SL training stage, as shown in FIG. 2, may be different from those in the general SSRL framework. To be specific, instead of following the generated paths, the SSRL agent may be configured to select actions based on the probability defined by the policy network. In this way, in this embodiment, the SSRL agent may be granted more freedom of exploration and/or may be prevented from getting stuck with the early rewarded paths. In this manner, in this embodiment, since collecting all correct paths and creating state-label pair is feasible for a deterministic environment like the KGs, the SSRL framework and/or the SSRL network may be trained by minimizing the distance between the policy network output and labels instead of maximizing the expected reward. The information density of the SL objective may be higher than the expected reward used in the general SSRL framework as the SSRL agent can get more contextual information. Therefore, in an embodiment, the distributional mismatch issue may be solved to some extent. The superiority of the SL training strategy is shown experimentally in the Examples section, provided below, in which the SSRL framework is compared with Deeppath.

Additionally, in an embodiment, during the RL stage of the SSRL framework, as shown in FIG. 2, the action at time t may be sampled from the policy distribution and/or may be applied to the environment in accordance with Eq. 7:

$${a}_{t} \sim Categorical ( {π}_{t} ) \qquad ( 7 )$$

In this embodiment, the reward Rₜ may be collected at time t. The goal is maximizing the reward expectation, L_{RL}(θ)= [symbol] _{π}(Rₜ). Using a likelihood of ratio calculation within the SSRL framework, in this embodiment, the derivative of the expectation of reward may be rewritten as the expectation of the derivative of reward, and/or one sample may be taken to update the parameters θ of the policy network with stochastic gradient ascent in accordance with Eq. 8:

$$θ ← θ + η {∇}_{θ} {L}_{RL} ( θ ) \qquad ( 8 )$$

In this above equation, L_{RL}(θ) represents the loss for each sample at time t, in accordance with Eq. 9 and Eq. 10:

$${L}_{RL} ( θ ) = log {π}_{t} ( {a}_{t} ) {G}_{t} \qquad ( 9 )$$

$${G}_{t} = {\sum }_{k = t}^{T} {γ}^{k - 1} {R}_{k} \qquad ( 10 )$$

In the above equations, Gₜ represents the discount accumulated reward with discount factor γ.

The following example(s) is (are) provided for the purpose of exemplification and is (are) not intended to be limiting.

### EXAMPLES

### Example 1

### The Combination of SL and RL (SSRL) Performance in a Deterministic Environment

To prove the superiority of combining SL and RL of the SSRL system for the KGC task, the pros and cons of SL and RL in terms of coverage, learning speed, and/or feasibility are analyzed and disclosed below.

Since all the correct actions are marked as ones and the loss function of SL is to minimize the distance between the policy and the label at each decision step, the SL agent aims to find all possible paths from the start entity to the target entity. However, the goal of the RL agent is to find at least one correct path, so it can be rewarded when it reaches the target entity. There is no motivation for the RL to find more correct paths as long as it already finds one. The cross-entropy loss of the SL agent allows it to learn as if it were taking every action possible at each step of its training while the RL agent is constrained to taking and learning from only one action. Hence, the SL agent tries to cover more correct paths than the RL agent. This wide coverage allows SL agents to perform well in situations that RL agents perform poorly in, primarily unfamiliar situations with large numbers of possible actions.

While SL agents in general learn faster than RL ones, in the implementation the RL agent learns faster since the SL and RL portions of training have different objectives, i.e. RL aims to find at least one correct path while SL aims to minimize the difference between the policy outputted by the agent and a correct answer label of all valid actions from the current state. In both cases, actions are selected based on the policy estimated by the deep neural network.

Another disadvantage of SL is its label generating process, which consumes additional computational resources. For large KGs such as FB15K-237 and FB60K1, generating labels for all training queries borders on infeasible, making pure SL impractical. RL methods are conductible for most KGs as there is no requirement to generate and store path labels.

In order to combine the strengths of SL and RL, the 2-stage SSRL training paradigm is proposed. Compared to the pure-RL method, the SSRL agent is warmed up to have a wider coverage so it achieves better performance.

In order to analyze the performance of the SSRL method on different types of graphs, graph statistics such as the number of entities, edges and facts in each KG and the average and median graph degrees are summarized in TABLE I, provided below. Among all these graphs, FB15K-237 has the least number of entities, but the highest degree. It is more densely connected than other KGs, so it is most challenging dataset for the SSRL method as generating labels for it is both time and resource consuming.

### Experimental Results

The SSRL method was evaluated on four large KGs with different properties from different domains. To analyze the performance of the SSRL on different types of graphs, graph statistics such as the number of entities, edges, and facts in each KG and the average and median graph degrees are summarized in TABLE 1, provided below. Among these graphs, the dataset FB15K-237 has the least number of entities but has the highest degree and is more densely connected than other KGs; as such, the FB15K-237 is the most challenging dataset is the most challenging for the SSRL method to generate labels since it is both time and resource consuming.

TABLE 1

| | | | | Degree | |
|---|---|---|---|---|---|
| Dataset | # Entities | # Rel | # Fact | Average | Median |
| FB15K-237 | 14,505 | 237 | 272,115 | 19.74 | 14 |
| WN18RR | 40,945 | 11 | 86,835 | 2.19 | 2 |
| NELL-995 | 75,492 | 200 | 154,213 | 4.07 | 1 |
| FB60K | 69,514 | 1,327 | 268,280 | 4.35 | 4 |

To compare the SSRL method of the SSRL system to other path-based methods (e.g., NeuralLP, M-Walk, MINERVA, and/or MultiHopKG, with MINERVA and/or MultiHopKG used as the baseline) for the four large KG datasets, the hyperparameters of the RL agents are set as the same as the related baselines, and the hyperparameters of the SL agents are summarized in TABLE 2, provided below. The evaluation results are shown in TABLE 3 and TABLE 4, provided below. The results of the NeuralLP and M-Walk methods were derived from (Das et al. 2018) and (Shen et al. 2018), and the results of the MINERVA and MultiHopKG methods are regenerated on the best hyperparameters reported to date.

TABLE 2

| Dataset | Model | β | λ | Learning rate |
|---|---|---|---|---|
| FB15K-237 | SL | 0.0002 | 0.02 | 1⁻³ |
| FB60K | RL | 0.2 | 0.02 | 1⁻³ |
| | SL | 0.02 | 0.02 | 1⁻³ |
| NELL995 | SL | 0.02 | 0.02 | 1⁻³ |
| WN18RR | SL | 0.02 | 0.002 | 1⁻³ |

TABLE 3

| | | | | MINERVA | | MultiHopKG | |
|---|---|---|---|---|---|---|---|
| Dataset | Metric | NeuralLP | M-Walk | Original | SSRL | Original | SSRL |
| FK15K-237 | Hits@1 | 16.6 | 16.5 | 21.7 | 22.3 | 30.8 | 31.9 |
| | | | | | (+0.6) | | (+1.1) |
| | Hits@3 | 24.8 | 24.3 | 32.5 | 34.5 | 43.3 | 44.9 |
| | | | | | (+2) | | (+1.6) |
| | Hits@10 | 34.8 | — | 44.5 | 47.6 | 55.6 | 56.8 |
| | | | | | (+3.1) | | (+1.2) |
| | MRR | 22.7 | 23.2 | 29.3 | 30.5 | 39.1 | 40.4 |
| | | | | | (+1.2) | | (+1.3) |
| WN18RR | Hits@1 | 37.6 | 41.4 | 44.9 | 45.9 | 39.0 | 38.2 |
| | | | | | (+1) | | (−0.8) |
| | Hits@3 | 46.8 | 44.5 | 49.3 | 50.0 | 44.8 | 45.9 |
| | | | | | (+0.7) | | (+1.1) |
| | Hits@10 | 65.7 | — | 54.6 | 55.4 | 50.5 | 51.1 |
| | | | | | (+0.8) | | (+0.6) |
| | MRR | 46.3 | 43.7 | 48.0 | 49.1 | 43.1 | 43.0 |
| | | | | | (+1.1) | | (−0.1) |
| NELL-995 | Hits@1 | — | 68.4 | 65.3 | 71.4 | 65.7 | 69.4 |
| | | | | | (+6.1) | | (+3.7) |
| | Hits@3 | — | 81.0 | 79.7 | 80.5 | 84.9 | 87.5 |
| | | | | | (+0.8) | | (+2.6) |
| | Hits@10 | — | — | 82.3 | 83.5 | 88.0 | 89.1 |
| | | | | | (+1.2) | | (+1.1) |
| | MRR | — | 75.4 | 72.6 | 76.2 | 75.8 | 78.9 |
| | | | | | (+3.6) | | (+3.4) |

TABLE 4

| Metric | MINERVA | SS-MINERVA |
|---|---|---|
| Hits@1 | 36.2 | 37.0(+0.8) |
| Hits@3 | 42.0 | 43.6(+1.4) |
| Hits@10 | 48.4 | 50.1(+1.7) |
| MRR | 40.2 | 41.4(+1.2) |

From the results in TABLE 3 and TABLE 4, as provided above, the SSRL method consistently outperforms the baseline model for all metrics (i.e., the SSRL on top of the MINERVA baseline, referred to as SS-MINERVA, outperforms MINERVA; and the SSRL on top of the MultiHopKG, referred to as SS-MultiHopKG, outperforms MultiHop KG). In addition, the SSRL method achieves state-of-the-art results on all datasets evaluated. Although NeuralLP obtains the highest score on the Hits@10 metric on the WN18RR dataset due to the performance gap between the baseline models and the NeuralLP method.

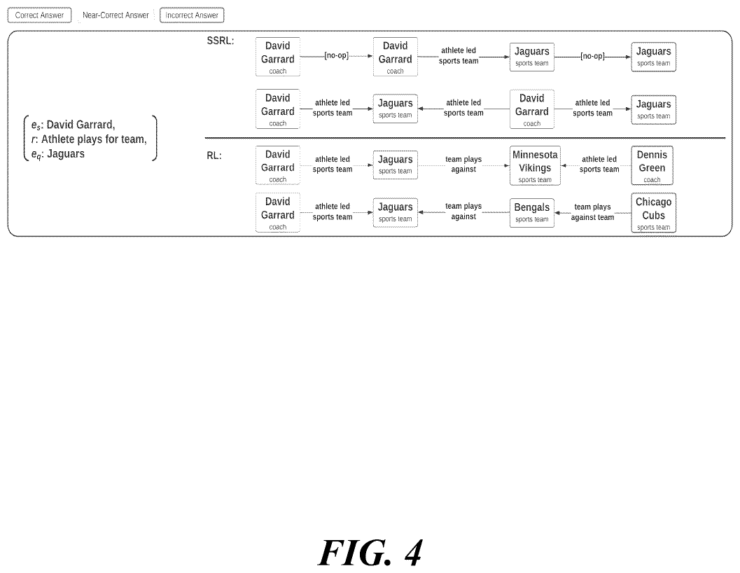

In this same manner, FIG. 4 depicts example reasoning paths that demonstrate the differences between SSRL and RL agents. Overall, it was found that the SSRL agent is superior at finding intuitive reasoning paths than the pure RL agent, arriving at correct or nearly correct answers consistently and taking appropriate paths to get there. The RL agent appears to only find organizations in general, and the relations it takes quickly diverge from r. In this manner, the failures of the RL agent appears to be due to the lack of ability to use the context of eₛ in conjunction with the context of r. The RL agent knows to look for an organization, finding the sports team, but does not understand based on starting at an athlete to narrow its search to specific sports teams. In contrast, as shown in FIG. 4, the SSRL agent is able to travel through these related concepts. For example, where eₛ=David Garrard, r=athlete plays for team, and e_{q}=Jaguars, the SSRL agent either arrives and then stops early at the correct answer or circles back to it while the RL agent immediately overshoots the correct answer and fails to circle back. As stated above, from this example, it can be seen that the RL agent understands to look for “athlete” and “sports team” based on r, but fails to infer from the specified athlete to narrow its search to specific football teams.

As such, both the RL and SSRL agents develop good understanding of what relations mean in isolation, however, only the SSRL agent of the SSRL system is able to develop a meaningful understanding of the relations in context of connecting two nodes in knowledge base. Accordingly, this is due to the information density of the SL pretraining method, disclosed above, which at each step gives the information about every action that can lead the agent to a correct answer, such that the SSRL agent may be allowed to get a better sense of how the relations it is learning work in a broader graph context.

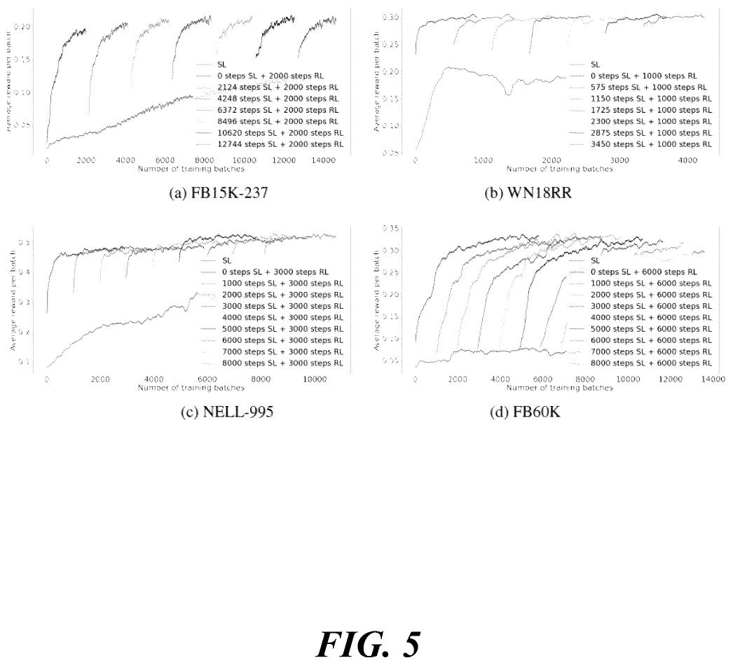

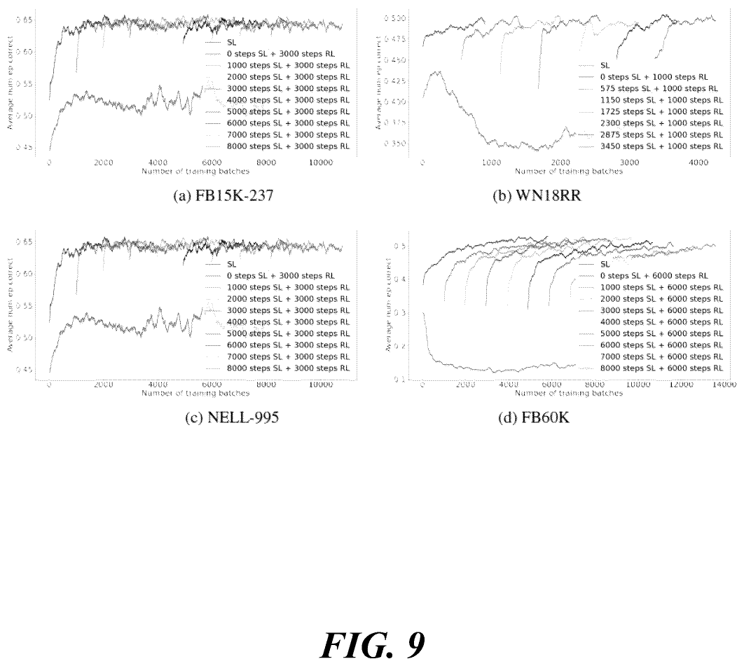

As shown in FIG. 5, the learning curves of different SL training steps followed by a RL agent show that the RL agent learns much faster than the SL agent, since the goal of the SL agent is to learn the statistics of the entire underlying environment, as opposed to the narrower goal of the RL agent (i.e., to find at least one path from the start entity to the end entity). Although SL alone cannot achieve results comparable to RL from both a speed and performance perspective, pretraining with the SL method helps the agent to avoid time-consuming exploration for queries with large action space. As such, the SL pretraining stage helps the RL agent find the correct paths for difficult queries by expanding its coverage among all the queries. In this manner, FIG. 5 and FIG. 9 both depict a graphical depiction of learning curves (plotting the percentage of correct trials vs. the number of training batches) with different supervised learning pretraining steps followed by reinforced learning steps.

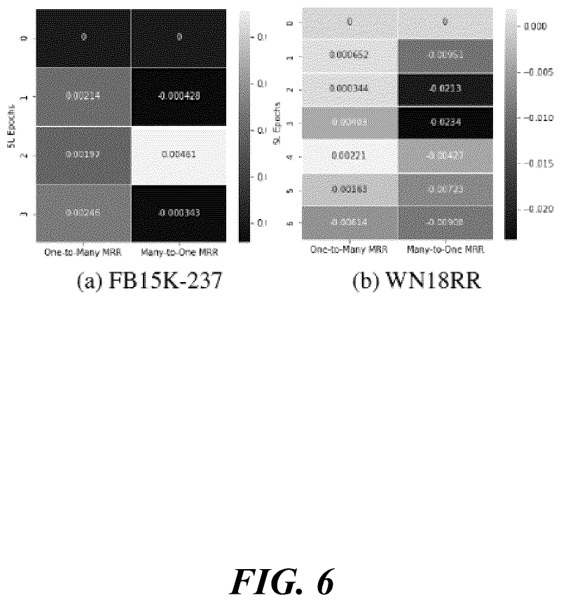

To verify results for the SSRL method, in an embodiment, the performance of the SSRL method is compared for to-many queries (in which there are more than one correct answer, |Eₐₗₗ|>1) and for to-one queries (in which there is only one correct answer, |Eₐₗₗ|=1). Generally, the action space for to-many queries is larger than the action space for to-one queries. Giving the agent a lead when the action space is large helps the agent to find more correct paths, thereby achieving better performance. For example, in this embodiment, as shown in FIG. 6, the MRR values on a to-many query set and on a to-one query set, showing that the SL is more helpful for to-many queries.

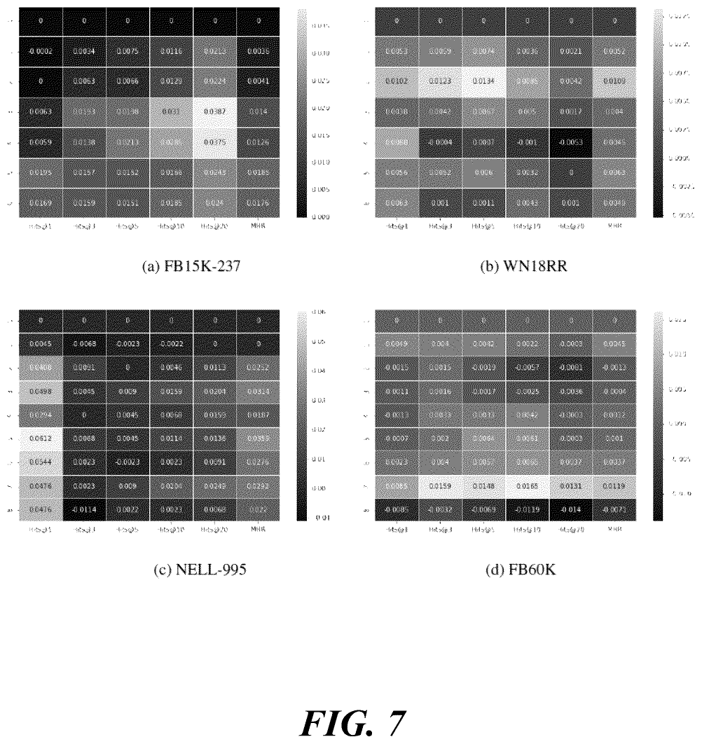

As shown in FIG. 7, the objective functions for SL and RL methods are different. Increasing the SL training steps may not always improve performance. The Hits and MRR metrics are shown in FIG. 7 for different SL pretraining epochs. The results show that increasing the SL pretraining steps usually improves the performance on all metrics before decreasing. As SL training progresses to a certain point, the differences in objectives begin to hinder the agent when the switch from SL to RL occurs. For example, in an embodiment, the agent on RL achieves its best performance with three SL epochs pretraining (for example, on FB15K-237); similarly, in an embodiment, the agent on RL achieves its best performance with two epochs pretraining (for example, on WN18RR).

Since generating labels for all training data is infeasible, in an embodiment, only partial labels are used for the SL training stage. TABLE 5, provided below, shows the percentage of labeled data that is used among the entire training set (in addition, the results shown in TABLE 3 and TABLE 4, provided above, are also based on partial label pretraining). From these results, pretraining partial labels is feasible for large datasets.

TABLE 5

| Epoch | FB15K-237 | WN18RR | NELL-995 | FB60K |
|---|---|---|---|---|
| 1 | 61.0% | 81.6% | 100.0% | 21.3% |
| 2 | 84.8% | 96.6% | 100.0% | 37.9% |
| 3 | 94.0% | 99.5% | 100.0% | 51.0% |
| 4 | 97.7% | 99.9% | 100.0% | 61.4% |
| 5 | 99.1% | 100.0% | 100.0% | 69.6% |
| 6 | 99.6% | 100.0% | 100.0% | 69.6% |
| 7 | — | — | 100.0% | 76.0% |
| 8 | — | — | 100.0% | 81.0% |

From TABLE 3 and TABLE 4, provided above, it can be seen that the improvements of SSRL to RL on different KG datasets are quite different. The improvement on NELL-995 datasets are significant. However, the improvement in WWN18RR and FB60K is only slight. Two potential reasons for this are the following: (1) the imbalanced training data for different relation types; and/or (2) the small graph degree (number of edges connecting to each edge).

In order to verify these two assumptions, the distribution of relations in the training set is shown within FIG. 7. On NELL, where the agent performs the best on out of all the datasets, there is an even distribution of relation types that show up with different frequencies in the dataset. This means that the agent is seeing a good sample of the different query types and trains well on all of them. On WN18RR and FB60K, the distributions of relation types are very skewed.

For WN18RR, where the improvement of SSRL on RL is the smallest, only two types of relations comprise more than 75% of the dataset while the others appear comparatively infrequently. Since the goal of SL is to learn the underlying distribution based on labeled data and encourage the agent to explore paths it would not otherwise, pretraining on these skewed distributions would encourage the agent to find more correct paths on the dominate relations, so it achieves higher overall accuracy on the whole training set. However, it may sacrifice performance on less common relations, where finding even one correct path is difficult. Furthermore, the idea behind SL is that by teaching the agent this underlying distribution it may take potentially advantageous paths it otherwise would not take; if the dataset is mostly homogeneous (e.g. sharply skewed towards a select few relations), there is little that SL could show the agent that it would not find during RL stage. As a result, SL pretraining does not help in terms of Hits@k when k is large on sharply skewed datasets like WN18RR.

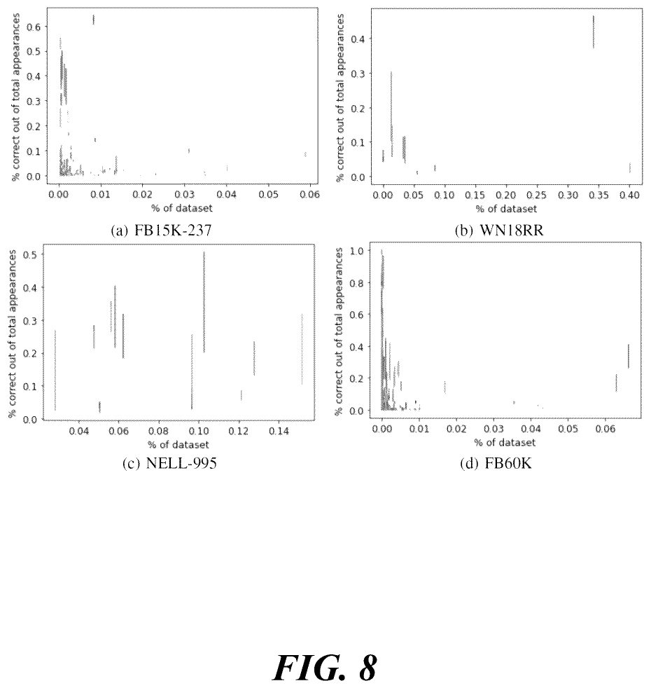

For FB60K, FIG. 7 depicts that the trial in which a correct path was found for the highest percentage of queries uses 7000 SL steps. In addition, the graphs as depicted in FIG. 5 track the average reward throughout the batch, which includes multiple trials for each query. The analysis of agent performance by relation type included in FIG. 8 shows that FB60K is the only dataset containing numerous relations with a near 100% fact prediction success rate, implying that it contains facts that are easier for the agent to understand. Intuitively, the immediately strong performance on these “low hanging fruit” will increase the average performance towards the beginning of training, but as increasing durations of SL pretraining force the agent to generalize to more complex relations, its success rate on these relations naturally falls, resulting in a decreasing average performance and an increasing percentage of queries for which a correct path is found. This matches the graph and heatmap presented in FIG. 5 and FIG. 7.

To back up these claims, learning curves were plotted with Hit@20 as the metric in FIG. 9. SL graphs show negative trends on skewed datasets, i.e., WN18RR and FB60K. This is reasonable because the target of SL is to minimize the cross-entropy loss and therefore maximize the overall accuracy. It is noted that the final performance on Hits@20 can be fixed by the RL training stage. This also shows the importance of the RL training stage in the SSRL system.

It was also observed that the SSRL system performs well on FB15K-237, where the relation-type distribution is also skewed (although it is less skewed than FB60K and WN18RR). The excellent performance is believed to be due to the high graph degree, where the SL are particularly helpful. TABLE 1, provided above, shows that the median degree of FB15K-237 is 14 whereas other datasets are less than 4.

Comparison with DeepPath:

The effectiveness of the SL pre-training method was also evaluated on the link prediction task solved by DeepPath, in comparison to DeepPath's SL pre-training. Since DeepPath tests each relation separately, to make a fair comparison, the SL pretraining algorithm is modified to use a normalized histogram of number of correct paths per relation (as the space of relations is the action space) at the current state and substitute it for DeepPath's original SL pretraining method during that portion of training.

The results of these tests on the NELL-995 and FB15K-237 datasets are presented in TABLE 6, provided below, and the performance for each relation is shown in TABLE 7 and TABLE 8, also provided below. It is believed that the superior performance derived from the SSRL method is due to two key differences in the SSRL method: the information density of the SL objective and the freedom of exploration the agent is granted.

In an embodiment, the primary advantage of the SSRL method of the SSRL system may be that at each time step, the label compared with the agent's computed action probabilities contains contextualized information about every path which can be taken from the current state to the correct e_{q} for the query. This information density allows the agent to learn more at each time step than if it was following a single randomly selected example path. Furthermore, these labels contain information about paths through entities with a low degree that would be less likely to appear in a path randomly sampled from the pool of correct paths. Overall, in this embodiment, this allows the agent of the SSRL system to learn about entities in the context of the graph as a whole rather than in isolation or in the context of a single query, allowing greater generalization.

Additionally, in an embodiment, the secondary advantage of the SSRL method of the SSRL system may be that the actions taken are selected by the agent instead of according to a pre-selected path. Selecting the actions for the agent inherently means that the agent is being trained in situations it might be unlikely to encounter while traversing the graph on its own, making the knowledge gained less applicable. In essence, in this embodiment, the SSRL method of the SSRL system may allow the agent to work and/or correct its misunderstandings as they reveal themselves, rather than simply showing it the correct answer and/or moving on.

In an embodiment, the SSRL system may be configured to warm up its parameters by using automatically generated partial labels. As such, the pure SL and RL for KGR task are disclosed above, such that it is shown that the supervised pretraining followed by reinforcement training may combine the advantage of both the SL and RL (i.e., the SSRL framework achieves state of art performance on four large KG datasets) and/or the SSRL agent may consistently outperform the RL baseline with all Hits@k and/or MRR metrics. To compare with the general SSRL framework, in this embodiment, the SSRL pretraining method may be adapted to link prediction task, such that the superiority of the SL strategy may be proven experimentally (i.e., as disclosed in Example 1).

TABLE 6

| Data | Metric | SSRL | DeepPath |
|---|---|---|---|
| FB15K-237 | MAP | 48.5 | 46.9 |
| | SR | 0.055 | 0.029 |
| NELL-995 | MAP | 0.73 | 0.663 |
| | SR | 0.127 | 0.057 |

TABLE 7

| | MAP | | SR | |
|---|---|---|---|---|
| Relation | SSRL | DeepPath | SSRL | DeepPath |
| PhoneServiceLocation | 0.31 | 0.49 | 0.014 | 0.01 |
| CelebrityRomanticRelationship | 0.51 | 0.57 | 0.06 | 0.08 |
| EducationalInstitutionCampus | 1 | 1 | 0.06 | 0.08 |
| FilmDirector | 0.44 | 0.43 | 0.05 | 0.04 |
| FilmCinematography | 0.19 | 0.26 | 0.00 | 0.00 |
| FilmFromCountry | 0.52 | 0.48 | 0.03 | 0.02 |
| FilmLanguage | 0.50 | 0.59 | 0.004 | 0.006 |
| FilmMusic | 0.29 | 0.27 | 0.028 | 0.014 |
| FilmWrittenBy | 0.56 | 0.56 | 0.14 | 0.08 |
| PersonNationality | 0.62 | 0.18 | 0.016 | 0.004 |
| AdministrativeDivisionOfCapital | 0.85 | 0.83 | 0.47 | 0.25 |
| LocationContains | 0.52 | 0.51 | 0.02 | 0.01 |
| SymptomOfDisease | 0.48 | 0.48 | 0.00 | 0.004 |
| ArtistOrigin | 0.46 | 0.46 | 0.024 | 0.028 |
| PersonFoundedOrganization | 0.28 | 0.24 | 0.027 | 0.00 |
| OrganizationHeadquartersCity | 0.51 | 0.45 | 0.13 | 0.02 |
| MemberOfOrganization | 0.22 | 0.22 | 0.09 | 0.003 |
| LeadsOrganization | 1 | 1 | 0.003 | 0.00 |
| CauseOfDeath | 0.83 | 0.84 | 0.002 | 0.00 |
| LanguagesSpoken | 0.35 | 0.35 | 0.00 | 0.006 |
| PersonNationality | 0.62 | 0.18 | 0.016 | 0.004 |
| PlaceOfBirth | 0.47 | 0.51 | 0.178 | 0.032 |
| IsReligion | 0.23 | 0.23 | 0.00 | 0.00 |
| MarriedTo | 0.38 | 0.45 | 0.164 | 0.043 |
| SpecializationOf | 0.44 | 0.36 | 0.012 | 0.00 |
| CityHasSportsTeam | 0.47 | 0.43 | 0.003 | 0 |
| PlaysFootballPosition | 0.32 | 0.31 | 0.014 | 0.016 |
| TeamPlaysSport | 0.42 | 0.42 | 0.00 | 0.00 |
| EventInLocation | 0.37 | 0.35 | 0.007 | 0.00 |
| TVProgramFromCountry | 0.79 | 0.65 | 0.022 | 0.027 |
| TVProgramGenre | 0.18 | 0.18 | 0.004 | 0.00 |
| TVProgramLanguage | 0.53 | 0.45 | 0.047 | 0.009 |
| MEAN | 0.49 | 0.47 | 0.055 | 0.029 |

TABLE 8

| | MAP | | SR | |
|---|---|---|---|---|
| Relation | SSRL | DeepPath | SSRL | DeepPath |
| AgentBelongsToOrganization | 0.577 | 0.580 | 0.220 | 0.194 |
| AthleteHomeStadium | 0.830 | 0.830 | 0.043 | 0.002 |
| AthletePlaysForTeam | 0.733 | 0.730 | 0.096 | 0.036 |
| AthletePlaysInLeague | 0.578 | 0.588 | 0.012 | 0.006 |
| AthletePlaysSport | 0.840 | 0.765 | 0.002 | 0.00 |
| OrganizationHeadquarteredInCity | 0.790 | 0.790 | 0.310 | 0.172 |
| OrganizationHiredPerson | 0.748 | 0.700 | 0.186 | 0.038 |
| PersonBornInLocation | 0.699 | 0.699 | 0.176 | 0.194 |
| PersonLeadsOrganization | 0.792 | 0.789 | 0.232 | 0.002 |
| TeamPlaysInLeague | 0.835 | 0.292 | 0.012 | 0.036 |
| TeamPlaysSport | 0.649 | 0.491 | 0.012 | 0.006 |
| WorksFor | 0.691 | 0.699 | 0.224 | 0.00 |
| MEAN | 0.730 | 0.663 | 0.127 | 0.057 |

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

D. Yu, C. Zhu, Y. Fang, W. Yu, S. Wang, Y. Xu, X. Ren, Y. Yang, and M. Zeng, “KG-FiD: Infusing knowledge graph in fusion-in-decoder for open-domain question answering,” in Proceedings of the 60th Annual Meeting of the Association for Computational Linguistics (Volume 1: Long Papers). Dublin, Ireland: Association for Computational Linguistics, May 2022, pp. 4961-4974. [Online] Available: https://aclanthology.org/2022.acl-long.340.
H. He, A. Balakrishnan, M. Eric, and P. Liang, “Learning symmetric collaborative dialogue agents with dynamic knowledge graph embeddings,” in Proceedings of the 55th Annual Meeting of the Association for Computational Linguistics (Volume 1: Long Papers). Vancouver, Canada: Association for Computational Linguistics, July 2017, pp. 1766-1776. [Online]. Available: https://aclanthology.org/P17-1162.
S. Moon, P. Shah, A. Kumar, and R. Subba, “OpenDialKG: Explainable conversational reasoning with attention-based walks over knowledge graphs,” in Proceedings of the 57th Annual Meeting of the Association for Computational Linguistics. Florence, Italy: Association for Computational Linguistics, July 2019, pp. 845-854. [Online]. Available: https://aclanthology.org/P19-1081.
X. Huang, J. Zhang, D. Li, and P. Li, “Knowledge graph embedding based question answering,” in Proceedings of the twelfth ACM international conference on web search and data mining, 2019, pp. 105-113 s.
R. Das, S. Dhuliawala, M. Zaheer, L. Vilnis, I. Durugkar, A. Krishnamurthy, A. Smola, and A. McCallum, “Go for a walk and arrive at the answer: Reasoning over paths in knowledge bases using reinforcement learning,” in ICLR, 2018.
Y. Shen, J. Chen, P.-S. Huang, Y. Guo, and J. Gao, “M-walk: Learning to walk over graphs using monte carlo tree search,” Advances in Neural Information Processing Systems, vol. 31, 2018.
X. V. Lin, R. Socher, and C. Xiong, “Multi-hop knowledge graph reasoning with reward shaping,” in Proceedings of the 2018 Conference on Empirical Methods in Natural Language Processing, EMNLP 2018, Brussels, Belgium, October 31-Nov. 4, 2018, 2018.
W. Xiong, T. Hoang, and W. Y. Wang, “Deeppath: A reinforcement learning method for knowledge graph reasoning,” in Proceedings of the 2017 Conference on Empirical Methods in Natural Language Processing (EMNLP 2017). Copenhagen, Denmark: ACL, September 2017.
H. Ravichandar, A. S. Polydoros, S. Chernova, and A. Billard, “Recent advances in robot learning from demonstration,” Annual review of control, robotics, and autonomous systems, vol. 3, pp. 297-330, 2020.
K. Toutanova, D. Chen, P. Pantel, H. Poon, P. Choudhury, and M. Gamon, “Representing text for joint embedding of text and knowledge bases,” in Proceedings of the 2015 Conference on Empirical Methods in Natural Language Processing. Lisbon, Portugal: Association for Computational Linguistics, September 2015, pp. 1499-1509. [Online]. Available: https://aclanthology.org/D15-1174.
Z. Cao, Q. Xu, Z. Yang, X. Cao, and Q. Huang, “Geometry interaction knowledge graph embeddings,” in AAAI Conference on Artificial Intelligence, 2022.
L. Chao, J. He, T. Wang, and W. Chu, “Pairre: Knowledge graph embeddings via paired relation vectors,” arXiv preprint arXiv:2011.03798, 2020.
R. Li, Y. Cao, Q. Zhu, G. Bi, F. Fang, Y. Liu, and Q. Li, “How does knowledge graph embedding extrapolate to unseen data: a semantic evidence view,” in Proceedings of the AAAI Conference on Artificial Intelligence, vol. 36, no. 5, 2022, pp. 5781-5791.
T. Song, J. Luo, and L. Huang, “Rot-pro: Modeling transitivity by projection in knowledge graph embedding,” Advances in Neural Information Processing Systems, vol. 34, pp. 24 695-24 706, 2021.
B. Yang, W. Yih, X. He, J. Gao, and L. Deng, “Embedding entities and relations for learning and inference in knowledge bases,” in 3rd International Conference on Learning Representations, ICLR 2015, San Diego, CA, USA, May 7-9, 2015, Conference Track Proceedings, Y. Bengio and Y. LeCun, Eds., 2015. [Online]. Available: http://arxiv.org/abs/1412.6575.
T. Dettmers, P. Minervini, P. Stenetorp, and S. Riedel, “Convolutional 2d knowledge graph embeddings,” in Proceedings of the AAAI conference on artificial intelligence, vol. 32, no. 1, 2018.
K. Toutanova, V. Lin, W.-t. Yih, H. Poon, and C. Quirk, “Compositional learning of embeddings for relation paths in knowledge base and text,” in Proceedings of the 54th Annual Meeting of the Association for Computational Linguistics (Volume 1: Long Papers). Berlin, Germany: Association for Computational Linguistics, August 2016, pp. 1434-1444. [Online]. Available: https://aclanthology.org/P16-1136.
R. Das, A. Neelakantan, D. Belanger, and A. McCallum, “Chains of reasoning over entities, relations, and text using recurrent neural networks,” in Proceedings of the 15th Conference of the European Chapter of the Association for Computational Linguistics: Volume 1, Long Papers. Valencia, Spain: Association for Computational Linguistics, April 2017, pp. 132-141. [Online]. Available: https://aclanthology.org/E17-1013.
K. Guu, J. Miller, and P. Liang, “Traversing knowledge graphs in vector space,” in Empirical Methods in Natural Language Processing (EMNLP), 2015.
N. Lao, T. Mitchell, and W. W. Cohen, “Random walk inference and learning in a large scale knowledge base,” in Proceedings of the 2011 Conference on Empirical Methods in Natural Language Processing. Edinburgh, Scotland, UK.: Association for Computational Linguistics, July 2011, pp. 529-539. [Online]. Available: https://aclanthology.org/D11-1049.
A. Neelakantan, B. Roth, and A. McCallum, “Compositional vector space models for knowledge base completion,” in Proceedings of the 53rd Annual Meeting of the Association for Computational Linguistics and the 7th International Joint Conference on Natural Language Processing (Volume 1: Long Papers). Beijing, China: Association for Computational Linguistics, July 2015, pp. 156-166. [Online]. Available: https://aclanthology.org/P15-1016.
W. Liu, A. Daruna, Z. Kira, and S. Chernova, “Path ranking with attention to type hierarchies,” in Proceedings of the AAAI Conference on Artificial Intelligence, vol. 34, no. 03, 2020, pp. 2893-2900.
F. Yang, Z. Yang, and W. W. Cohen, “Differentiable learning of logical rules for knowledge base reasoning,” Advances in neural information processing systems, vol. 30, 2017.
T. Rockt″aschel and S. Riedel, “End-to-end differentiable proving,” in Advances in Neural Information Processing Systems 30: Annual Conference on Neural Information Processing Systems 2017, 4-9 Dec. 2017, Long Beach, CA, USA, 2017, pp. 3791-3803. [Online]. Available: http://papers.nips.cc/paper/6969-end-to-end-differentiable-proving.
C. Fu, T. Chen, M. Qu, W. Jin, and X. Ren, “Collaborative policy learning for open knowledge graph reasoning,” in Proceedings of the 2019 Conference on Empirical Methods in Natural Language Processing and the 9th International Joint Conference on Natural Language Processing (EMNLP-IJCNLP). Hong Kong, China: Association for Computational Linguistics, November 2019, pp. 2672-2681. [Online]. Available: https://aclanthology.org/D19-1269
P. Florence, C. Lynch, A. Zeng, O. A. Ramirez, A. Wahid, L. Downs, A. Wong, J. Lee, I. Mordatch, and J. Tompson, “Implicit behavioral cloning,” in Conference on Robot Learning. PMLR, 2022, pp. 158-168.
T. Osa, J. Pajarinen, G. Neumann, J. A. Bagnell, P. Abbeel, J. Peters et al., “An algorithmic perspective on imitation learning,” Foundations and Trends® in Robotics, vol. 7, no. 1-2, pp. 1-179, 2018.
J. Ho and S. Ermon, “Generative adversarial imitation learning,” Advances in neural information processing systems, vol. 29, 2016.
S. Hochreiter and J. Schmidhuber, “Long short-term memory,” Neural computation, vol. 9, no. 8, pp. 1735-1780, 1997.
A. Bordes, N. Usunier, A. Garcia-Duran, J. Weston, and O. Yakhnenko, “Translating embeddings for modeling multirelational data,” in Advances in Neural Information Processing Systems, C. Burges, L. Bottou, M. Welling, Z. Ghahramani, and K. Weinberger, Eds., vol. 26. Curran Associates, Inc., 2013. [Online]. Available: https://proceedings.neurips.cc/paper/2013/file/1cecc7a77928ca8133fa24680a88d2f9-Paper.pdf.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A method of finding reasoning pathways in a knowledge graph, in real-time, the method comprising the steps of:
automatically generating, via at least one processor of a computing device, partial labels for a dataset, wherein the partial labels are generated from a subset of the knowledge graph;
pretraining, via a supervised learning module, a reinforced learning module, or both, a neural network; and
subsequent to generating partial labels, pretraining the neural network, or both, automatically selecting, via the at least one processor of the computing device, an optimal reasoning pathway from a start entity to a target entity for a question-and-answer query using the knowledge graph.

2. The method of claim 1, wherein the step of automatically generating partial labels of a dataset further comprises the step of, determining the start entity and the target entity.

3. The method of claim 2, wherein the step of automatically generating partial labels of a dataset further comprises the step of, calculating a correct path between the start entity and the target entity.

4. The method of claim 3, wherein the step of automatically generating partial labels of a dataset further comprises the step of, removing, for each correct path, any correct paths that include a self-loop outside of the calculated correct path.

5. The method of claim 4, wherein the step of automatically generating partial labels of a dataset further comprises the step of, adding to a target set, for each correct path, all parent nodes for each node visited from the start entity to the target entity.

6. The method of claim 5, wherein the step of automatically generating partial labels of a dataset further comprises the step of, generating the partial labels based on the target set.

7. The method of claim 6, wherein the step of pretraining a neural network further comprises the step of, performing a supervised learning module using the generated partial labels by sampling, via an agent, a policy action on the target set to map each correct path between the start entity and the target entity.

8. The method of claim 7, wherein the step of pertaining a neural network further comprises the step of, subsequent to performing the supervised learning module, performing a reinforced learning module using the sampled policy action by applying the sampled policy action to the dataset to maximize a reward for the agent.

9. The method of claim 8, further comprising the step of, retraining, via the at least one processor, the supervised learning module, the reinforced learning module or both, wherein the supervised learning module, the reinforced learning module or both is trained by minimizing a distance between the sampled policy action and the partial labels.

10. A path-finding system of finding reasoning pathways in a knowledge graph, the path-finding system comprising:
at least one processor; and
a non-transitory computer-readable medium operably coupled to the at least one processor, the computer-readable medium having computer-readable instructions stored thereon that, when executed by the at least one processor, cause a path-finding system to select an optimal reasoning pathway from a start entity to a target entity for a question-and-answer query by executing instructions comprising:
automatically generating, via at least one processor of a computing device, partial labels for a dataset, wherein the partial labels are generated from a subset of a knowledge graph;
pretraining, via a supervised learning module, a reinforced learning module, or both, a neural network; and
subsequent to generating partial labels, pretraining the neural network, or both, automatically selecting, via the at least one processor of the computing device, the optimal reasoning pathway from the start entity to the target entity for the question-and-answer query using the knowledge graph.

11. The system of claim 10, wherein the step of automatically generating partial labels of a dataset of the executed instructions further comprises the step of, determining the start entity and the target entity.

12. The system of claim 11, wherein the step of automatically generating partial labels of a dataset of the executed instructions further comprises the step of, calculating a correct path between the start entity and the target entity.

13. The system of claim 12, wherein the step of automatically generating partial labels of a dataset of the executed instructions further comprises the step of, removing, for each correct path, any correct paths that include a self-loop outside of the calculated correct path.

14. The system of claim 13, wherein the step of automatically generating partial labels of a dataset of the executed instructions further comprises the step of, adding to a target set, for each correct path, all parent nodes for each node visited from the start entity to the target entity.

15. The system of claim 14, wherein the step of automatically generating partial labels of a dataset of the executed instructions further comprises the step of, generating the partial labels based on the target set.

16. The system of claim 15, wherein the step of pretraining a neural network of the executed instructions further comprises the step of, performing a supervised learning module using the generated partial labels by sampling, via an agent, a policy action on the target set to map each correct path between the start entity and the target entity.

17. The system of claim 16, wherein the step of pertaining a neural network of the executed instructions further comprises the step of, subsequent to performing the supervised learning module, performing a reinforced learning module using the sampled policy action by applying the sampled policy action to the dataset to maximize a reward for the agent.

18. The system of claim 17, wherein the executed instructions further comprise the step of, retraining, via the at least one processor, the supervised learning module, the reinforced learning module or both, wherein the supervised learning module, the reinforced learning module or both is trained by minimizing a distance between the sampled policy action and the partial labels.

19. A method of automatically finding reasoning pathways in a knowledge graph, the method comprising the steps of:
generating partial labels for a dataset by:
determining a start entity and a target entity;
calculating a correct path between the start entity and the target entity;
removing, for each correct path, any correct paths that include a self-loop outside of the calculated correct path;
adding to a target set, for each correct path, all parent nodes for each node visited from the start entity to the target entity;
generating the partial labels based on the target set; and
wherein the partial labels are generated from a subset of the knowledge graph;
pretraining a neural network by:
performing a supervised learning module using the generated partial labels by sampling, via an agent, a policy action on the target set to map each correct path between the start entity and the target entity; and
after performing the supervised learning module, performing a reinforced learning module using the sampled policy action by applying the sampled policy action to the dataset to maximize a reward for the agent; and
subsequent to generating the partial labels, pretraining the neural network, or both, automatically selecting an optimal reasoning pathway from the start entity to the target entity for a question-and-answer query using the knowledge graph.

20. The method of claim 19, further comprising the step of, retraining, via the at least one processor, the supervised learning module, the reinforced learning module or both, wherein the supervised learning module, the reinforced learning module or both is trained by minimizing a distance between the sampled policy action and the partial labels.
